(19) United States
(12) Patent Application Publication
(10) Pub. No.: US 2022/0257455 A1
(43) Pub. Date: Aug. 18, 2022

(54) A Single Cavity Stimulation Device For Stimulating Various Parts Of The Body Using Suction And Vibrations

(71) Applicants: Ruben DEITZ, Santa Clarita, CA (US); SHOTS BV, Beneden-Leeuwen (NL)

(72) Inventors: Oscar Heijnen, Beneden-Leeuwen (NL); Ruben Deitz, Santa Clarita, CA (US)

(21) Appl. No.: 17/630,489

(22) PCT Filed: Jul. 30, 2019
(86) PCT No.: PCT/IB2019/056510

§ 371 Date: Jan. 26, 2022

(51) Int. Cl. A61H 19/00; A61H 9/00; A61H 23/02

(52) U.S. Cl. CPC A61H 19/30; A61H 9/0057; A61H 23/0263; A61H 2201/501; A61H 2201/0111; A61H 2201/1654; A61H 2201/5097

(57) ABSTRACT

A single cavity stimulation device for stimulating various parts of the body using suction and vibrations having a waterproof housing with a power supply and a motor with a motor controller. An eccentric mechanism, a shaft and a vibration mechanism are also attached to the motor. A single flexible membrane comprising a chamber having a closed interior portion attached to the shaft and an open exterior portion for placing over a body part.

### FIELD OF THE INVENTION

The present invention is in the technical field of body part stimulators and more particularly to a single cavity stimulation device for stimulating various parts of the body using suction and vibrations that is simpler to build, more reliable and has a more economic inner structure.

### BACKGROUND

One of the most popular adult pleasure product categories in the market today is suction toys. Exactly as the name suggests, it provides a suction/vibrating effect which can stimulate various intimate parts of the body, and are very popular with consumers as they provide a unique experience. Due to this fact, there are a lot of suction power products in the pleasure product market. Current products use a suction cup and the silicone body as separate individual component to achieve a suction effect. The inner structures of existing suction power toys in the market are very complicated to assemble, production cost are very high, they are noisy and they are not 100% waterproof to meet IPX7 standards.

For example, U.S. Pat. No. 9,763,851 titled, “Stimulation Device,” that issued on Sep. 19, 2017 and is directed to a stimulation device for erogenous zones, in particular for the clitoris. The device has at least one pressure field generator with at least a first chamber and at least a second chamber with at least one opening for placing onto a body part, and at least one connection element which connects the first chamber to the second chamber, and with a drive unit which changes the volume of the first chamber in such a way that, by way of the connection element, a pressure field is generated in the second chamber and serves for stimulation; and a control device which controls the drive unit. This type of unit is extremely complicated, costly and difficult to build and maintain. It comprises:

(1) A second chamber having first and second openings.

(2) A connection element having a first opening and a separate second opening thereby forming a straight channel connecting the single opening of the first chamber with the first opening of the second chamber.
(3) The first chamber is connected with the second chamber solely by the connection element.
(4) A drive unit that changes a volume of the first chamber in such a manner that a stimulating pressure field is generated in the second chamber via the connection element.

Keeping this device clean and free of bodily fluids that can be trapped in the second chamber makes this device unsuitable for repeated use.

In another example, United States Patent Application No. 2017/0281457, titled “Compression Wave Massage Device, is similar to the device above, but only has a single chamber. Although, the single chamber fixed the sanitary issues, it still requires a suction cup to create the claimed pressure wave that is used for stimulation. Additionally, the suction cup as a relatively narrow range of sizes that will work with the device. If the suction cup is too large, the device will not work. This limits the size of the cavity that can be constructed, the pressure that can be produced and is still complicated to build.

Each of the above devices also have additional parts that make the product less reliable and noisy.

Therefore, there is a need for a single cavity stimulation device for stimulating various parts of the body using suction and vibrations, overcoming the limitations of the prior art.

### BRIEF DESCRIPTION OF THE DRAWINGS

These and other features, aspects and advantages of the present invention will become better understood with regard to the following description, appended claims, and accompanying figures where:

FIG. 1 is perspective side view of a first single cavity stimulation device for stimulating various parts of the body using suction and vibrations, according to a first embodiment of the device;

FIG. 2 is perspective side view of a second single cavity stimulation device for stimulating various parts of the body using suction and vibrations, according to a second embodiment of the device;

FIG. 3 is perspective side view of a third single cavity stimulation device for stimulating various parts of the body using suction and vibrations, according to a third embodiment of the device;

FIG. 4 is perspective side view of a fourth single cavity stimulation device for stimulating various parts of the body using suction and vibrations, according to a fourth embodiment of the device;

FIG. 5 is perspective side view of a fifth single cavity stimulation device for stimulating various parts of the body using suction and vibrations, according to a fifth embodiment of the device; and

FIG. 6 is a cutaway interior view of the single cavity stimulation device for stimulating various parts of the body using suction and vibrations shown in FIG. 1.

### SUMMARY

The present invention provides a suction product device with a simpler inner structure and assembly process. After numerous verification and testing, the present invention comprises a new inner structure that can achieve this function better, simpler to manufacture at a lower cost while reducing the noise level, making the product 100% waterproof (IPX7) and increases the lifespan, reliability and quality of the product.

There is provided a single cavity stimulation device for stimulating various parts of the body using suction and vibrations. The device has a waterproof housing, a power supply, a motor and a motor controller. There is an eccentric mechanism attached to the motor and a shaft connected to the eccentric mechanism. There is also a single flexible membrane comprising a chamber having a closed interior portion attached to the shaft and an open exterior portion for placing over a body part affixed to the housing. The waterproof housing and the single flexible membrane are attached to each other.

The power supply can be an internal battery, an internal induction charged battery, a magnetic contact power supply, a power cord, or an external power block for providing power to a device or any other known or unknown power supply capable of running the device.

The motor comprises an output shaft that is connected to the eccentric mechanism. The motor controller can be manually set, automatically set or both manually and automatically set. The motor controller can adjust a suction pressure, a vibration speed, or both a suction pressure and a vibration speed of the device. There is also a remote control for operating the device. The remote control can be wired, wireless or both wired and wireless depending upon the application. The remote control can also be a smart phone application operably connected to the motor control and comprises preset motor control settings, random motor control settings or both preset and random motor control settings.

The eccentric mechanism is configured to deform the single flexible membrane to create a suction in the chamber formed by the single flexible membrane that varies with the speed of the motor. The eccentric mechanism also can have a vibration mechanism, for vibrating the waterproof housing and creating suction in the chamber formed from the single flexible membrane. The shaft connected to the eccentric mechanism can also have a vibration mechanism for vibrating the waterproof housing to provide extra stimulation to a body part.

The single flexible membrane is constructed from material that is washable, hygienic, anti-bacterial, and does not deteriorate when exposed to oils or lubricants. In a preferred embodiment, the single flexible membrane is constructed from silicone.

The closed interior portion of the single flexible membrane attached to the shaft is constructed of a sufficient amount of material to withstand repeated use of the maximum suction and vibration provided by the motor. The open exterior portion of the single flexible membrane is between 1 mm and 50 mm in diameter.

There is also provided a method for using a single cavity stimulation device for stimulating various parts of the body using suction and vibrations. First, powering the device on. Then, placing the open exterior chamber over a body part. Next, adjusting the vibration amount. Then, adjusting the suction amount. Next, finish using the device. Then, turning off the power to the device. Next, cleaning the device using a mild soap and water. Finally, drying the device and storing it in a clean place.

### DETAILED DESCRIPTION OF THE INVENTION

The present invention overcomes the limitations of the prior art by providing a single cavity stimulation device for stimulating various parts of the body using suction and vibrations that. Unlike the prior art, the device has a new and novel inner structure that can achieve better results than the prior art, by combining the suction cup and a silicone body as one component. This makes it easier to manufacture at a lower cost while reducing the noise level, making the device 100% waterproof, to meeting IPX7 standards. The device also comprises fewer moving parts and components, reducing noise and increasing the lifespan, reliability and quality of the device. Overall, this creates a much better, more reliable product than what is in the market today.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, certain terminology is used to describe certain features of one or more embodiments of the invention.

The term “power supply” refers to any known or future electrical systems that can provide power to a device for operating the device described herein. This also covers, battery power, induction charging, contact charging, power cords, or any other known methods for providing power to a device.

Various embodiments provide a single cavity stimulation device for stimulating various parts of the body using suction and vibrations. One embodiment of the present invention provides a single cavity stimulation device for stimulating various parts of the body using suction and vibrations. In another embodiment, there is provided a method for using the system. The system and method will now be disclosed in detail.

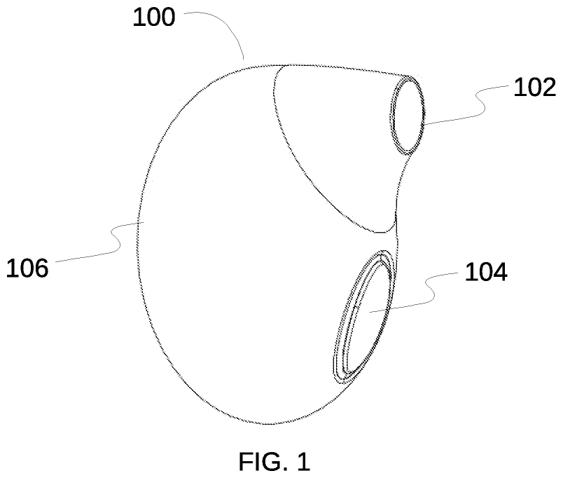

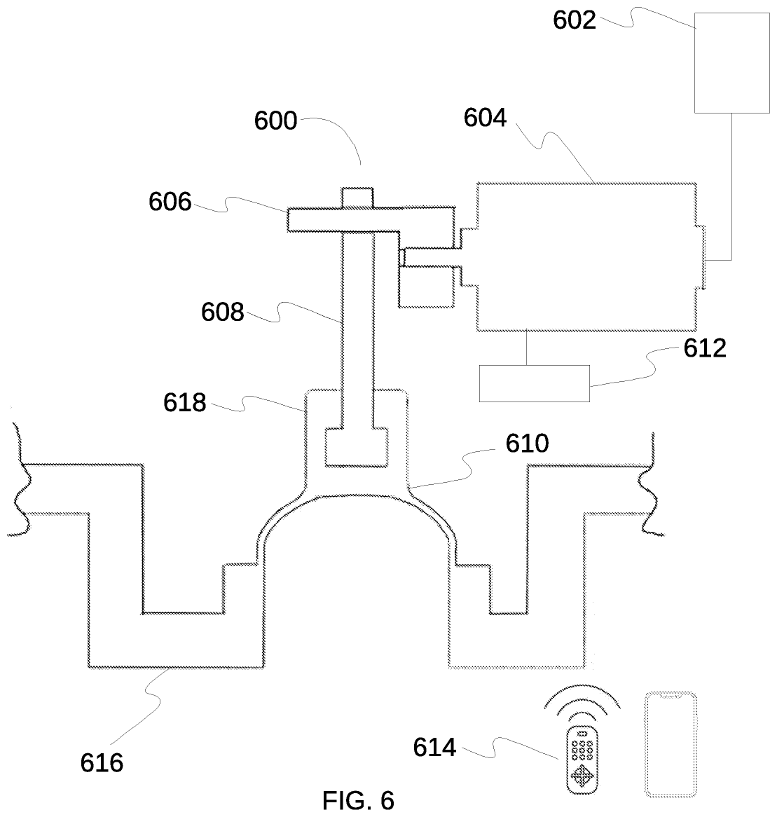

Referring now to FIG. 1, there is shown a perspective side view of a first single cavity stimulation device for stimulating various parts of the body using suction and vibrations, according to a first embodiment 100 of the device. In this first embodiment 100, the device comprises a single flexible membrane open exterior portion 102 for placing over a body part, a motor controller 104, and a waterproof housing 106. The device also comprises a power supply 602 affixed to the waterproof housing 106, a motor 602 attached to the power supply 602, an eccentric mechanism 604 attached to the motor, and a shaft 606 connected to the eccentric mechanism 604 and the single flexible membrane 606 as can be seen in FIG. 6. IN this first embodiment 100, the single flexible membrane open exterior portion 102 is a minimal size, as is the waterproof housing 106 for portability and discretion. The motor controller 104 is simply an on/off switch that uses preset speeds for both suction and vibration of the single flexible membrane open exterior portion 102 when it is placed over a body part.

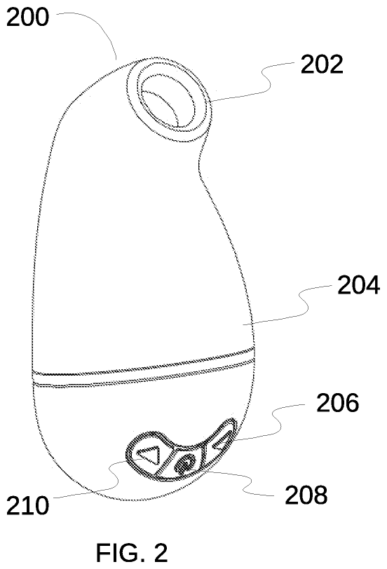

Referring now to FIG. 2, there is shown a perspective side view of a second single cavity stimulation device for stimulating various parts of the body using suction and vibrations, according to a second embodiment 200 of the device. The second embodiment 200 comprises a larger single flexible membrane open exterior portion 202 than found in the previous figure. Additionally, the waterproof housing 204 is also larger. The motor controls 206, 208 and 210 control the motor 602 in a variety of manual settings to increase the vibration and suction using motor control 206, decreasing vibration and suction using motor control 210 and powering the device on/off using motor control 208.

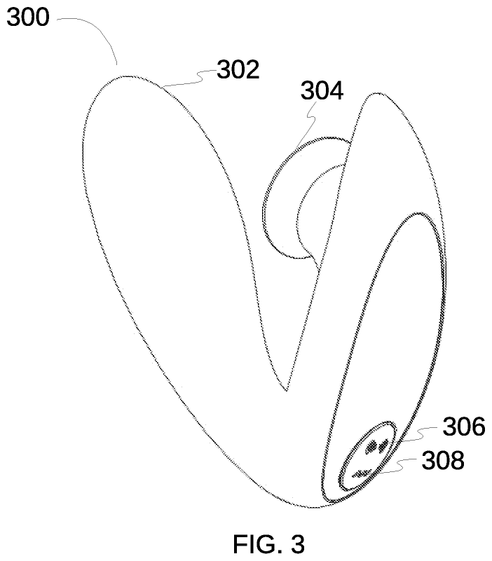

Referring now to FIG. 3, there is shown a perspective side view of a third single cavity stimulation device for stimulating various parts of the body using suction and vibrations, according to a third embodiment 300 of the device. In this third embodiment 300 of the device, the waterproof housing 302 is shaped so that the vibrations provided by the motor 604 stimulate additional body regions for added pleasure. A single flexible membrane open exterior portion 304 is positioned so it and the waterproof housing 302 work in tandem to stimulate a plurality of a users body. Motor controls 306 and 308 provide increase/decrease control 306 over motor 604 vibration and suction. The motor control 308 turns the third embodiment 300 of the device on and off.

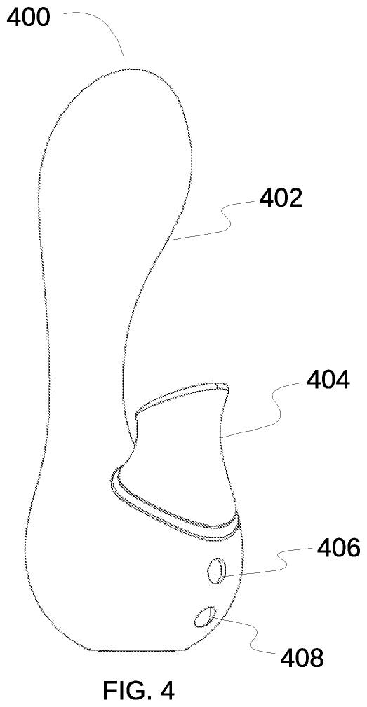

Referring now to FIG. 4, there is shown a perspective side view of a fourth single cavity stimulation device for stimulating various parts of the body using suction and vibrations, according to a fourth embodiment 400 of the device. In this fourth embodiment 400 of the device, the waterproof housing 402 is shaped so the housing can be inserted into the user's body while a single flexible membrane open exterior portion 404 is positioned so it and the waterproof housing 302 work in tandem to stimulate the user internally and externally. The motor controls 406 and 408 are positioned on the waterproof housing 402 so that the user can adjust the vibration ans the suction.

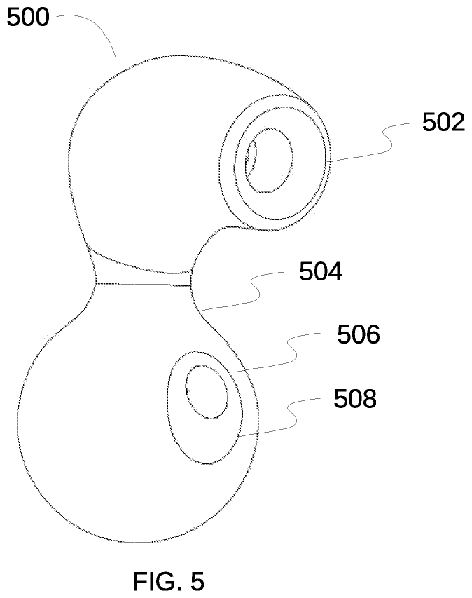

Referring now to FIG. 5, there is shown a perspective side view of a fifth single cavity stimulation device for stimulating various parts of the body using suction and vibrations, according to a fifth embodiment 500 of the device. In the fifth embodiment 500 of the device, a a single flexible membrane open exterior portion is larger than the previously describe devices above. This larger opening covers a larger area of the user's body portion that is to be stimulated. The waterproof housing 504 is also shaped so that the device can be held in a single hand comfortably without loosing control of the device. Additionally the motor controls 506 and 508 are designed to be activated and used by a single hand.

Referring now to FIG. 6, there is shown a cutaway interior view of a single cavity stimulation device 600 for stimulating various parts of the body using suction and vibrations shown in FIG. 1. As can be seen, the device comprises a power supply 602 that is connected to a motor 604. An output shaft of the motor is connected to an eccentric mechanism 606 that can provide suction, vibration or both suction and vibration. The eccentric mechanism 606 is connected to a shaft 608 that transmits the eccentric motion and/or vibrations to a single cavity membrane 610. A motor controller 612 controls the functions of the motor 604.

The power supply 602 is selected from the group consisting of an internal battery, an internal induction charged battery, a magnetic contact power supply, a power cord, or an external power block for providing power to a device.

The motor controller 612 comprises instructions to the motor 604 that are issued through the motor control buttons (shown above). After receiving the instructions from the motor control button, a central processor on the motor controller 612 outputs a corresponding current to control the motor 604 to match the settings selected by the user. Additionally, the motor controller 612 can be manually set, automatically set or both manually and automatically set. Also, the motor controller 612 can adjust a suction pressure, a vibration speed, or both a suction pressure and a vibration speed of the device.

The eccentric mechanism 606 is correctly sized and has the appropriate eccentricity to maximize the suction sent to the single cavity membrane 610 without damaging it over prolonged usage. Optionally, the eccentric mechanism further comprises a vibration mechanism, for vibrating the waterproof housing 616 and creating suction in the chamber formed from the single flexible membrane 610.

The shaft 608 that is connected to the eccentric mechanism 606 has a length that is also maximized for creating the greatest suction possible in the single cavity membrane 610 without damaging it over prolonged usage. The eccentric mechanism 606 and the shaft 608 are configured together so that maximum suction and vibrations are available for the size of the single cavity membrane 610. Alternatively, the shaft 608 connected to the eccentric mechanism 606 can also comprises a vibration mechanism 618 for vibrating he single flexible membrane 610 and the waterproof housing 616.

Additionally, transmission components, comprising the motor 604, the eccentric mechanism 606 and the shaft 608, are configured to deform the single flexible membrane 610 to create a suction in the chamber formed by the single flexible membrane 610 that varies with the speed of the motor 604.

The single cavity membrane 610 diameter and thickness are matched to the power of the transmission components 604, 606 and 608 to provide the ideal working effect of the device 600. Unlike the inner structures of existing suction power toys currently available that are very complicated to assemble, expensive to produce, noisy and not 100% waterproof, the single cavity stimulation device 600 overcomes all those limitations by using only one cavity and no suction cups or channels. The single cavity membrane 610 is driven by the transmission components 604, 606 and 608 so that the air enters and leaves the open exterior portion of the single cavity membrane 610 and a contact position with the user's skin. Negative pressure and impact are quickly exchanged to achieve the effect of a stimulating massage with a suction/vibrating effect. This function can be widely used to stimulate various intimate parts of the body by creating a suction/vibrating massage effect. The single flexible membrane 610 is constructed from material that is washable, hygienic, anti-bacterial, and does not deteriorate when exposed to oils or lubricants, preferably silicone. The closed interior portion of the single flexible membrane 610 attached to the shaft 608 is constructed of a sufficient amount of material to withstand repeated use of the maximum suction and vibration provided by the motor. The open exterior portion of the single flexible membrane 610 is between 1 mm and 50 mm in diameter.

In another embodiment, the transmission components 604, 606 and 608 can be controlled by a remote control 614. The remote control can be wired, wireless or both wired and wireless depending on the technology used. Additionally, the remote control 614 can be a smart phone application wirelessly connected to the motor control 612. The smart phone application comprises preset motor control settings, random motor control settings or both preset and random motor control settings and the commands are sent wirelessly to the transmission components 604, 606 and 608.

There is also a method for using a single cavity stimulation device 600 for stimulating various parts of the body using suction and vibrations. First the device is powered on. Then, the open exterior portion of the single flexible membrane 610 is place over a body part to be stimulated. Next, the user can adjust the vibration amount, the suction amount or both the vibration amount and the suction amount using controls located on the housing. Once the user has finished using the device, the power is turned off. Then, the user can clean the unit using a mild soap and water solution. Finally, the user can either dry the device with an absorbent material or allow the device to air dry.

What has been described is a new and improved system for a, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A single cavity stimulation device for stimulating various parts of the body using suction and vibrations, the device comprising:
a) a waterproof housing;
b) a power supply affixed to the waterproof housing;
c) a motor attached to the power supply;
d) a motor controller attached to the motor;
d) an eccentric mechanism attached to the motor;
e) a shaft connected to the eccentric mechanism; and
f) a single flexible membrane comprising a chamber having a closed interior portion attached to the shaft and an open exterior portion for placing over a body part affixed to the housing.

2. The device of claim 1, where the waterproof housing and the single flexible membrane are attached to each other.

3. The device of claim 1, where the power supply is selected from the group consisting of an internal battery, an internal induction charged battery, a magnetic contact power supply, a power cord, or an external power block for providing power to a device.

4. The device of claim 1, where the motor comprises an output shaft that is connected to the eccentric mechanism.

5. The device of claim 1, where the motor controller can be manually set, automatically set or both manually and automatically set.

6. The device of claim 5, where the motor controller can adjust a suction pressure, a vibration speed, or both a suction pressure and a vibration speed of the device.

7. The device of claim 6 further comprising a remote control.

8. The device of claim 7, where the remote control is wired, wireless or both wired and wireless.

9. The device of claim 8, where the remote control is a smart phone application operably connected to the motor control.

10. The device of claim 9, where the smart phone application comprises preset motor control settings, random motor control settings or both preset and random motor control settings.

11. The device of claim 1, where the eccentric mechanism is configured to deform the single flexible membrane to create a suction in the chamber formed by the single flexible membrane that varies with the speed of the motor.

12. The device of claim 1, where the eccentric mechanism further comprises a vibration mechanism, for vibrating the waterproof housing and creating suction in the chamber formed from the single flexible membrane.

13. The device of claim 1, where the shaft connected to the eccentric mechanism further comprises a vibration mechanism for vibrating the waterproof housing.

14. The device of claim 1, where the single flexible membrane is constructed from material that is washable, hygienic, anti-bacterial, and does not deteriorate when exposed to oils or lubricants.

15. The device of claim 1, where the single flexible membrane is constructed from silicone.

16. The device of claim 1, where the closed interior portion of the single flexible membrane attached to the shaft is constructed of a sufficient amount of material to withstand repeated use of the maximum suction and vibration provided by the motor.

17. The device of claim 1, where the open exterior portion of the single flexible membrane is between 1 mm and 50 mm in diameter.

18. A method for using a single cavity stimulation device for stimulating various parts of the body using suction and vibrations, comprising the steps of:
a) powering the device on;
b) placing the open exterior chamber over a body part;
c) adjusting the vibration amount;
d) adjusting the suction amount;
e) finish using the device;
f) turning off the power to the device;
g) cleaning the device using a mild soap and water; and
h) drying the device.
